(19) United States
(12) Patent Application Publication
(10) Pub. No.: US 2023/0332455 A1
(43) Pub. Date: Oct. 19, 2023

(54) POWER PANEL SYSTEM AND CONTROL

(71) Applicant: GM Global Technology Operations LLC, Detroit, MI (US)

(72) Inventors: Charles Andrew Mallon, Howell, MI (US); Michael R. Colville, Fenton, MI (US); Edward J. Zentera, JR., Shelby Township, MI (US); James Nikolas Nelsen, Howell, MI (US); Ervin Colic, Troy, MI (US)

(21) Appl. No.: 17/724,065

(22) Filed: Apr. 19, 2022

(51) Int. Cl. E05F 15/622; E05B 81/56; E05B 83/24; E05B 81/14; E05B 81/04

(52) U.S. Cl. CPC E05F 15/622; E05B 81/04; E05B 81/14; E05B 81/56; E05B 83/243; E05Y 2400/31; E05Y 2400/32; E05Y 2400/40; E05Y 2800/10; E05Y 2900/536

(57) ABSTRACT

A power panel closure system may include a moveable panel and a panel driver energizable in a first direction associated with movement of the panel toward closing and energizable in a second direction associated with movement of the panel toward opening. A panel latch may have a primary latch state wherein the panel is held in a closed position. A control module may perform a panel opening sequence including energizing the panel driver in the first direction while the panel is being held in the closed position by the panel latch in the primary latch state, releasing the panel latch from the primary latch state, and energizing the panel driver in the second direction.

### INTRODUCTION

The subject disclosure relates to power panel systems. Power panel systems may move a panel using actuators. Power panel systems may employ latch mechanisms to secure a panel.

A panel in a primary latched position may be fully closed and secured, and may be biased toward opening by springs, compressible seals, panel support bumpers and the like. Such bias may provide an initial panel opening force when the latch is released. Such force may rapidly pop open the panel and result in objectionable noise and vibration. Once opened, one or more panel drivers may move the panel to a more fully open position. In some applications, the popped open panel may be retained in a secondary latched position by the latch mechanism, which maintains a slight opening of the panel but prevents the panel from opening further or from closing back into the primary latched position. The panel may be released from the secondary latched position, whereafter one or more panel drivers may move the panel to a more fully open position.

Latch mechanisms may employ actuators to release the latch mechanism from primary and secondary latch states. Latch mechanisms may employ actuators to cinch the panel from the secondary latched position into the primary latched position and establish the latch mechanism into the primary latch state.

### SUMMARY

In one exemplary embodiment, a power panel closure system may include a moveable panel, a panel driver energizable in a first direction associated with movement of the panel toward closing and energizable in a second direction associated with movement of the panel toward opening, a panel latch having a primary latch state wherein the panel is held in a closed position, and a control module performing a panel opening sequence including energizing the panel driver in the first direction while the panel is being held in the closed position by the panel latch in the primary latch state, releasing the panel latch from the primary latch state, and energizing the panel driver in the second direction.

In addition to one or more of the features described herein, the system may further include the panel latch having a secondary latch state wherein the panel is maintained in a partially open position, wherein energizing the panel driver in the second direction opens the panel into the partially open position establishing the panel latch into the secondary latch state.

In addition to one or more of the features described herein, the control module performing the panel opening sequence may further include releasing the panel latch from the secondary latch state.

In addition to one or more of the features described herein, energizing the panel driver in the second direction may open the panel beyond the partially open position.

In addition to one or more of the features described herein, energizing the panel driver in the second direction may include ramping up panel driver force.

In addition to one or more of the features described herein, energizing the panel driver in the second direction may include ramping up panel driver force for a predefined duration and subsequently reducing panel driver force prior to releasing the panel latch from the secondary latch state, wherein the control module performing the panel opening sequence may further include the control module performing the panel opening sequence further including releasing the panel latch from the secondary latch state.

In addition to one or more of the features described herein, the predefined duration may include one or more of a time limit, a displacement limit of the panel driver, and a force limit of the panel driver.

In addition to one or more of the features described herein, the control module performing the panel opening sequence may further include energizing the panel driver in the first direction when the panel is open beyond the partially open position to close the panel into the partially open position establishing the panel latch into the secondary latch state, cinching the panel from the partially open position while simultaneously energizing the panel driver in the first direction, pausing the cinching of the panel and the energizing of the panel driver for a predefined pause duration, and subsequent to the pause duration, cinching the panel while simultaneously energizing the panel driver in the first direction until the panel latch is in the primary latch state and the panel is held in the closed position.

In addition to one or more of the features described herein, energizing the panel driver in the first direction subsequent to the pause duration may include ramping up panel driver force.

In another exemplary embodiment, a method for operating a power panel closure system may include energizing a panel driver in a first direction associated with movement of the panel toward closing while the panel is latched in a primary latched position, unlatching the panel from the primary latched position, and energizing the panel driver in a second direction, the second direction associated with movement of the panel toward opening.

In addition to one or more of the features described herein, energizing the panel driver in the second direction may open the panel into a secondary latched position.

In addition to one or more of the features described herein, the method may further include unlatching the panel from the secondary latched position.

In addition to one or more of the features described herein, energizing the panel driver in the second direction may open the panel beyond the secondary latched position.

In addition to one or more of the features described herein, energizing the panel driver in the second direction may include ramping up panel driver force.

In addition to one or more of the features described herein, energizing the panel driver in the second direction may include ramping up panel driver force for a predefined duration and subsequently reducing panel driver force prior to unlatching the panel from the secondary latched position.

In addition to one or more of the features described herein, the predefined duration may include one or more of a time limit, a displacement limit of the panel driver, and a force limit of the panel driver.

In addition to one or more of the features described herein, the method may further include energizing the panel driver in the first direction when the panel is open beyond the secondary latched position to close the panel into the secondary latched position, cinching the panel from the secondary latched position while simultaneously energizing the panel driver in the first direction, pausing the cinching of the panel and the energizing of the panel driver for a predefined pause duration, and subsequent to the pause duration, cinching the panel while simultaneously energizing the panel driver in the first direction until the panel is latched in the primary latched position.

In addition to one or more of the features described herein, energizing the panel driver in the first direction subsequent to the pause duration comprises ramping up panel driver force.

In yet another exemplary embodiment, a power panel closure system for a vehicle may include a compartment located external to a passenger compartment of the vehicle, a moveable panel attached to the vehicle by a hinge and having a closed position relative to the compartment, a panel driver energizable in a first direction associated with movement of the panel toward the closed position and energizable in a second direction associated with movement of the panel away from the closed position, a panel latch having a primary latch state wherein the panel is held in the closed position, and a control module performing a panel opening sequence including energizing the panel driver in the first direction while the panel is being held in the closed position by the panel latch in the primary latch state, releasing the panel latch from the primary latch state, and energizing the panel driver in the second direction.

In addition to one or more of the features described herein, the compartment may include a compartment located between a front of the vehicle and the passenger compartment of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically illustrates an exemplary vehicle including a power panel closure system, in accordance with the present disclosure;

FIGS. 2A-2C illustrate various latch states of a latch mechanism, in accordance with the present disclosure;

FIG. 3 illustrates a panel opening sequence routine flow diagram, in accordance with the present disclosure;

FIG. 4 illustrates various charts of sensed and control parameters, in accordance with the present disclosure;

FIG. 5 illustrates a panel closing sequence routine flow diagram, in accordance with the present disclosure; and

FIG. 6 illustrates various charts of sensed and control parameters, in accordance with the present disclosure.

### DETAILED DESCRIPTION

The following description is merely exemplary in nature and is not intended to limit the present disclosure, its application or uses.

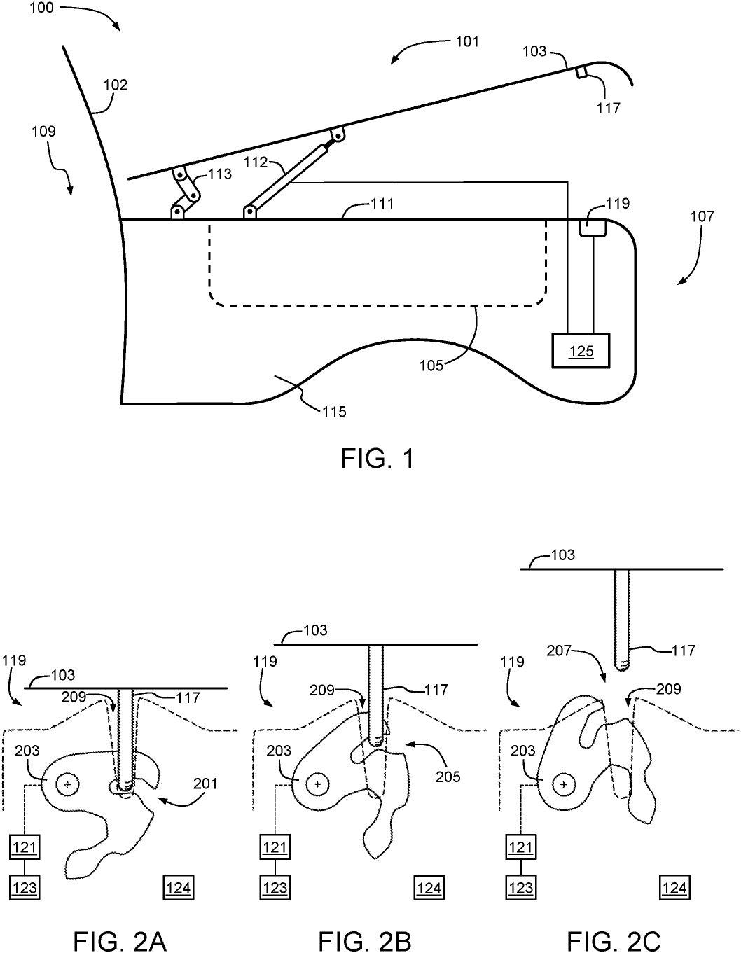

In accordance with an exemplary embodiment, FIG. 1 schematically illustrates an exemplary vehicle 100 including a power panel closure system 101. The vehicle 100 may include a number of movable panels, for example doors, lift gates, tail gates, side panels, trunk lids, hoods, hard and soft roof tops, etc. Such movable panels may be attached to the vehicle structure 111 such as by sliding (rail) or articulating (hinge) mechanisms which generally allow for movement of the panel through a continuum of positions between and including fully opened and fully closed. Hinge as used herein is understood to mean any such dynamic attachment of a panel to the vehicle 100. Such panels may provide ingress and egress to and from the vehicle 100 interior, reconfiguration of the vehicle 100, access to storage areas of the vehicle 100, service access to vehicle systems and components, etc.

The power panel closure system 101 may include a panel 103 for providing access to a compartment external to the passenger compartment 109 of the vehicle. Such a compartment may include, for example, a hardware bay containing serviceable components and systems such as, or related to, engines, electric drive units, HVAC and thermal management, transmission/transaxle, etc. Alternatively, the compartment may provide storage space such as, or similar to, a trunk. In the exemplary power panel closure system 101 of FIG. 1, a storage compartment 105 is located generally between the front 107 of the vehicle 100 and the passenger compartment 109 of the vehicle 100. The panel 103 is attached to a vehicle structure 111 by a hinge mechanism 113 which allows the panel a range of motion between a fully opened position and a fully closed position. In the fully closed position, the panel 103 may fit substantially flush with adjacent body panels of the vehicle 100, such as front quarter panel 115. As illustrated in the non-limiting example, the panel 103 is hinged closer to the windshield 102 although alternative hinge mechanism placements, for example toward the front 107 of the vehicle, are within the scope of the disclosure.

The power panel closure system 101 may include at least one striker 117 coupled to the panel 103 which cooperates with at least one latch mechanism 119 for various panel 103 latching related functions. Reference to latch mechanism 119 may refer to one or more latch mechanisms. The striker 117 may cooperate with a latch mechanism 119 in a primary latch state to retain the panel 103 in the fully closed, primary latch, position until released. Once released, the panel 103 may be free to open. The striker 117 may cooperate with the latch mechanism 119 in a secondary latch state to retain the panel 103 in a slightly open, secondary latch, position, for example around 30 mm-60 mm, sufficient for airflow into the storage compartment and finger access to a manual release lever for example. The latch mechanism 119 may be released from the secondary latch state to allow the panel 103 to move freely.

Additional reference to FIGS. 2A-2C illustrates portions of an exemplary latch mechanism 119 and striker 117 complement including a primary latch state and a secondary latch state as described herein. FIG. 2A represents a primary latch state 201 wherein a striker catch 203 captures the striker 117, which is within the striker passage 209 in a latch mechanism housing, to maintain the panel 103 in the fully closed, primary latch, position. FIG. 2B represents a secondary latch state 205 wherein a striker catch 203 captures the striker 117 to maintain the panel 103 in the slightly open, secondary latch, position. FIG. 2C represents an open latch state 207 wherein the striker 117 is no longer captured by the striker catch 203 and the panel is free to move. In the open latch state 207, the striker catch 203 is open to receive the striker 117 through striker passage 209 and establish the latch mechanism 119 in the secondary latch state 205 (FIG. 2B) or primary latch state 201 (FIG. 2A) as the striker 117 progresses into the striker passage 209. The latch mechanism 119 may include other mechanical components 121 such as release levers, driving and locking pawls, ratchets, springs, detents, cams, cables, rods, slides, etc. to provide for release, latch and motion functions of the striker catch 203 through the various states as described. The latch mechanism 119 may provide the latch states as described using two positions of a single striker catch 203 or may alternatively use separate striker catches or hooks for the primary latch state and the secondary latch state. The latch mechanism 119 may include at least one latch mechanism actuator 123 to impart motion to the latch mechanism 119 components 121 to release, latch and move the striker catch 203 through the various latch states as described. The latch mechanism actuator 123 may be commonly housed with other latch mechanism components or may be housed remotely therefrom. The latch mechanism 119 may include at least one latch mechanism sensor 124 used to determine or indicate the state of the latch mechanism 119. For example, latch mechanism sensor 124 may be a detent or cam driven switch indicating various rotational positions of the striker catch 203 or position of a release lever of the latch mechanism 119. Reference to latch mechanism actuator 123 may refer to one or more actuators, and reference to latch mechanism sensor 124 may refer to one or more sensors.

The power panel closure system 101 may further include at least one panel driver 112 for opening and closing the panel 103. The panel driver 112 may include at least one panel driver actuator (not separately illustrated) to impart motion to the panel driver 112. Reference to panel driver 112 may refer to one or more panel drivers. The exemplary panel driver 112 illustrated may a power strut or spindle drive having a rotary actuator (e.g., DC motor) which may be bi-directionally energized to extend or retract the power strut. Energizing the panel driver 112 is understood to have the same meaning as energizing the panel driver actuator. The exemplary panel driver 112 illustrated may include at least one panel driver sensor (not separately illustrated) used to determine or indicate the motion of the panel driver 112. For example, the sensor may be a rotation sensor (e.g., hall device) indicating rotation of the rotary actuator which has a known relationship to the power strut motion. Reference to a panel driver sensor may refer to one or more sensors.

Energizing the panel driver 112 in a first direction is associated with movement of the panel 103 toward closing and energizing the panel driver 112 in a second direction is associated with movement of the panel 103 toward opening.

Actuator as used herein may be any type of actuator including, for example, an electric actuator using an electric drive such as a rotary or linear motor or a hydraulic actuator using pistons. In the illustrated embodiment, the latch mechanism actuator 123 and the panel driver actuator may be electric actuators.

Electronic control of the power panel closure system 101 may be handled by a control module 125. As used herein, control module, module, control, controller, control unit, electronic control unit, processor and similar terms mean any one or various combinations of one or more of Application Specific Integrated Circuit(s) (ASIC), electronic circuit(s), central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, and in-plant and service-related networks including for over the air (OTA) software updates. Functions of the control module as set forth in this disclosure may be performed in a distributed control architecture among several networked control modules. Software, firmware, programs, instructions, routines, code, algorithms and similar terms mean any controller executable instruction sets including calibrations, data structures, and look-up tables. A control module has a set of control routines executed to provide described functions. Routines are executed, such as by a central processing unit, and are operable to monitor inputs from sensing devices and other networked control modules and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests. The control module 125 may communicate with wireless devices such as key fobs and smart devices such as smart phones through user applications requesting power panel closure system 101 operation via routines as described herein. The control module may also provision human machine interfacing and interaction through any other suitable human-machine interface (HMI) device including, for example, touch screen displays, dialogue managers, door, dash panel, center console switches and buttons, etc. for requesting power panel closure system 101 operation. The control module 125 may be signally coupled to panel driver 112 and latch mechanism 119 and additionally to other electrical components in the power panel closure system 101. More specifically, the control module may be signally coupled to the panel driver actuator, panel driver sensors, latch mechanism actuator 123, latch mechanism sensor 124 and panel sensors such as a panel open switch for indicating the panel in or out of the fully closed position.

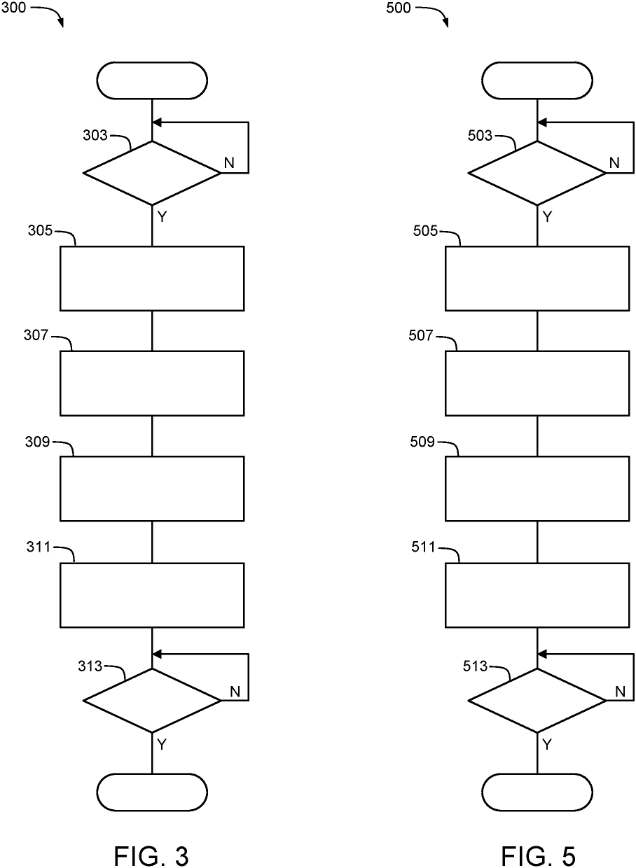

The power panel closure system 101 may respond to an operator request via a key fob or other short range wireless device such as a smart phone for example. An exemplary method for operating the power panel closure system 101 through a panel 103 opening sequence routine 300 is illustrated in a flow diagram of FIG. 3 which represents tasks embodied in executable code within control module 125 of FIG. 1. The tasks illustrated in the opening sequence routine 300 may be executed in the order and manner illustrated or may be executed in alternative orders or simultaneously, the opening sequence routine 300 being exemplary. The opening sequence routine 300 may include other tasks not illustrated including system diagnostics.

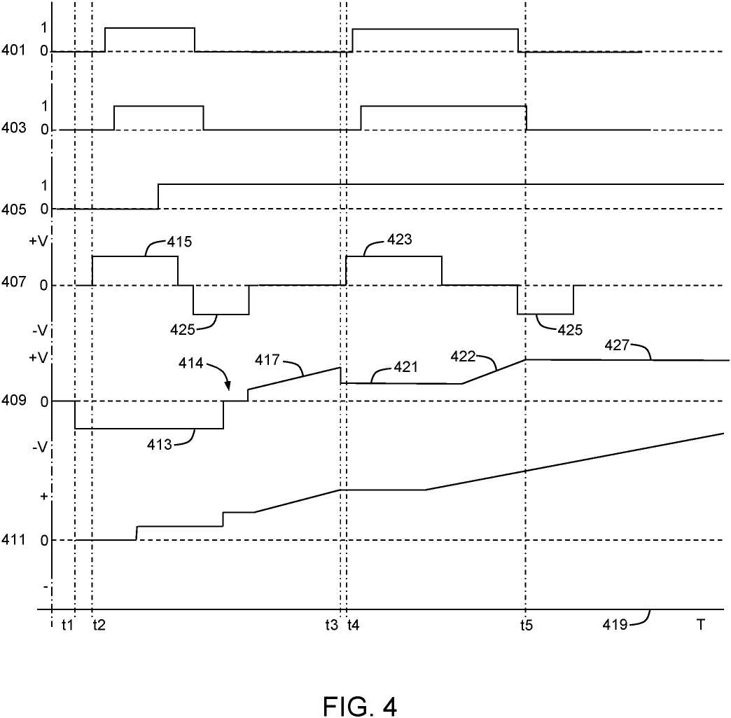

The opening sequence routine 300 may first initialize including clearing or populating memory locations and registers to establish initial settings, variables and calibrations as required and then essentially wait at 303 for receipt of an operator request to open the panel 103. At 305, the panel driver 112 may be commanded to close the panel 103. That is, the panel driver 112 may be energized in a direction associated with movement of the panel 103 toward closing. The panel 103, being in a fully closed position with the latch mechanism 119 in a primary latch state (201, FIG. 2A), may be biased toward opening by springs, compressible seals, panel support bumpers and the like. The opening bias forces are transferred, at least in part, through the striker 117 to the latch mechanism 119 (e.g., the striker catch 203). By energizing the panel driver 112 to urge the panel 103 toward closing, some or all such bias forces may be relieved from the striker and transferred to the panel driver 112. Essentially, the panel driver 112 may be energized to unload the latch mechanism 119. Advantageously, unloading the latch mechanism 119 may reduce the forces needed to unlatch the striker catch 203 from the primary latch state allowing derating of latch mechanism actuators, and may reduce or eliminate the bias forces effecting transient motion of the panel 103 immediately upon release of the striker catch 203 from the primary latch state. With reference to chart 409 in FIG. 4, a negative voltage 413 is applied to the panel driver 112 at time t1. The negative voltage corresponds to energization of the panel driver in a first direction associated with panel 103 closing. The voltage level may be between 0 volts and a nominal accessory voltage level for the vehicle, for example 12 volts. In one embodiment, the voltage applied may be about 5 volts but may vary in accordance with the particular application and design factors including the desired panel 103 closing force. In one embodiment, the voltage level may be established by pulse-width modulation (PWM). FIG. 4 contains other charts further described herein, all of which share a common horizontal time scale (T) 419.

At 307, the latch mechanism 119 may be commanded to release from the primary latch state (201, FIG. 2A). The release from the primary latch state may come after some delay from, or simultaneously with, commanding the panel driver 112 in the direction toward closing at 305. With reference to chart 407 in FIG. 4, a positive voltage 415 is applied to the latch mechanism actuator 123 at time t2. The positive voltage corresponds to energization of the latch mechanism actuator 123 in a first direction associated with releasing the striker catch 203 for free motion out of the primary latch state and into the secondary latch state (205, FIG. 2B). Latch release may be validated by state transitions of latch mechanism sensors 124 subsequent to time t2 (charts 401 and 403, FIG. 4) and a panel ajar sensor signal (chart 405, FIG. 4). The voltage level 415 may be between 0 volts and a nominal accessory voltage level for the vehicle, for example 12 volts. In one embodiment, the voltage applied may be about 5 volts but may vary in accordance with the particular application and design factors including the bias forces through the striker 117 and latch mechanism 119. In one embodiment, the voltage level may be established by pulse-width modulation (PWM). It may be appreciated that the difference between times t1 and t2 represents a delay between the respective actuations sufficient to unload the bias forces from the striker 117 and latch mechanism 119.

At 309, the panel driver 112 may be commanded to open the panel 103. That is, the panel driver 112 may be energized in a direction associated with movement of the panel 103 toward opening. The panel 103, with the latch mechanism 119 having been released from the primary latch state (201, FIG. 2A), may now be lifted by the panel driver 112 through the space between the primary latched position and the secondary latched position. Advantageously, this movement may be controlled by the panel driver 112 which may controllably unload the bias forces and then slightly lift the panel 103 up until motion is restricted by the latch mechanism 119 in the secondary latch state (205, FIG. 2B). With reference to chart 409 in FIG. 4, the applied voltage to the panel driver 112 may transition 414 from the negative voltage 413 to a positive voltage 417. In the illustrated embodiment, the transition 414 includes a duration when the applied voltage to the panel driver 112 is substantially zero. During such time, the panel driver 112 may unload the bias forces through mechanical friction and advantage effectively damping the energy release. Subsequently, the positive voltage 417 is applied to the panel driver 112 which corresponds to energization of the panel driver 112 in a second direction associated with panel 103 opening. Energization of the panel driver 112 in the second direction may move the panel through the space between the primary latched position and the secondary latched position and resist the panel 103 from sagging back toward closing. The voltage level may be between 0 volts and a nominal accessory voltage level for the vehicle, for example 12 volts. In one embodiment, the voltage applied may be about 5 volts but may vary in accordance with the particular application and design factors including the desired panel 103 opening force. In one embodiment, the voltage level may ramp up from an initial value, for example between 0 and 1 volt, thereby ramping up the corresponding opening force of the panel driver 112. In one embodiment, the voltage level may be established by pulse-width modulation (PWM). The ramping of the voltage may continue at a predetermined rate for a predefined duration, ending at time t3 (409, FIG. 4). In one embodiment, the predefined duration may terminate after a predefined time. In one embodiment, the predefined duration may terminate after a predefined displacement of the panel driver 112 has been reached as determined, for example, by a predefined number of hall counts from the rotation sensor (e.g., hall device) of the panel driver. In one embodiment, the predefined duration may terminate after a predefined panel driver 112 force limit has been reached, for example, by a predefined voltage limit on the positive voltage 417 applied to the panel driver 112. It is appreciated that the predefined duration may terminate in accordance with such timeout, panel displacement, panel driver 112 force limit, or other relevant considerations, events, or triggers and combinations thereof. With reference to chart 411 in FIG. 4, hall counts are illustrated accumulated over time, wherein panel driver 112 energization in the first direction closing the panel 103 adds counts and panel driver 112 energization in the second direction opening the panel 103 subtracts counts. Subsequent to the predefined duration ending at time t3, the energization of the panel driver 112 in the second direction may continue at a reduced force as exemplified by the lower voltage level 421 (409, FIG. 4). Alternatively, the voltage level may be reduced to zero if panel 103 sagging is sufficiently addressed by mechanical friction and advantage inherent in the panel driver 112, latch mechanism 119 spring forces or a latch reversal function. Advantageously, the lower voltage level 421 is sufficient to maintain the position of the panel 103 while reducing the forces at the striker 117 and latch mechanism 119 in advance of releasing the latch mechanism from the secondary latch state. As with the release from the primary latch state, unloading the latch mechanism 119 may reduce the forces needed to unlatch the striker catch 203 from the secondary latch state allowing derating of latch mechanism actuators, and may reduce or eliminate bias forces now from the panel driver 112 effecting transient motion of the panel 103 immediately upon release of the striker catch 203 from the secondary latch state.

At 311, the latch mechanism 119 may be commanded to release from the secondary latch state (205, FIG. 2B). The release from the secondary latch state may come after some delay from, or simultaneously with, commanding the panel driver 112 in the second direction toward opening at the lower voltage level 421 (409, FIG. 4). With reference to chart 407 in FIG. 4, a positive voltage 423 is applied to the latch mechanism actuator 123 at time t4. The positive voltage corresponds to energization of the latch mechanism actuator 123 in the first direction associated with releasing the striker catch 203. Latch release may be validated by state transitions of latch mechanism sensors 124 subsequent to time t4 (charts 401 and 403, FIG. 4) and a panel ajar sensor signal (chart 405, FIG. 4). The voltage level 423 may be between 0 volts and a nominal accessory voltage level for the vehicle, for example 12 volts. In one embodiment, the voltage applied may be about 5 volts but may vary in accordance with the particular application and design factors including the bias forces through the striker 117 and latch mechanism 119. In one embodiment, the voltage level may be established by pulse-width modulation (PWM). It may be appreciated that the difference between times t3 and t4 represents a delay between the respective actuations sufficient to reduce the bias forces from the panel driver 112 upon the striker 117 and latch mechanism 119.

Subsequent to release from the secondary latch state, the lower voltage level 421 applied to the panel driver 112 is increased to a positive voltage level 427. This continued energization of the panel driver 112 in the second direction may move the panel through the secondary latched space to more fully opened positions. The voltage level may be between 0 volts and a nominal accessory voltage level for the vehicle, for example 12 volts. In one embodiment, the voltage applied may be about 5 volts but may vary in accordance with the particular application and design factors including the desired panel 103 opening force. In one embodiment, the voltage level may ramp up 422 from the lower voltage level 421, thereby ramping up the corresponding opening force of the panel driver 112. In one embodiment, the voltage level may be established by pulse-width modulation (PWM). The ramping of the voltage may continue at a predetermined rate for a predefined duration, ending at time t5 (409, FIG. 4). In one embodiment, the predefined duration may terminate after a predefined time. In one embodiment, the predefined duration may terminate after a predefined displacement of the panel driver 112 has been reached as determined, for example, by a predefined number of hall counts from the rotation sensor (e.g., hall device) of the panel driver. In one embodiment, the predefined duration may terminate after a predefined panel driver 112 force limit has been reached, for example, by a predefined voltage limit on the positive voltage 427 applied to the panel driver 112. It is appreciated that the predefined duration may terminate in accordance with such timeout, panel displacement, panel driver 112 force limit, or other relevant considerations, events, or triggers and combinations thereof. Subsequent to the predefined duration ending at time t5, the energization of the panel driver 112 in the second direction may continue at the same or reduced force. Alternatively, the voltage level may be reduced to zero if panel 103 sagging is sufficiently addressed by mechanical friction and advantage inherent in the panel driver 112, mechanical detent or spring forces at the hinge mechanism 113.

With reference to chart 407 in FIG. 4, in one embodiment negative voltage 425 may be applied to the latch mechanism actuator 123 subsequent to releasing the striker 203 from each of the primary latch state and the secondary latch state. The negative voltage 425 corresponds to energization of the latch mechanism actuator 123 in a second direction. This reversal of the latch mechanism actuator 123 serves to back drive the latch mechanism 119 components 121 to prepare for release of the secondary latch state or for receiving the striker 117 in the open latch state, establishment of the secondary latch state, and preparing the latch mechanism for cinching. As used herein, cinching is understood to refer to closure movement of the panel 103 from the secondary latched position with the panel latch mechanism 119. In other latch mechanizations where the latch mechanism 119 components 121 are self back driving, reversal of the latch mechanism actuator 123 is not required. In other embodiments, the latch mechanism 119 components 121 may be spring loaded and back drive once the latch mechanism actuator 123 is deenergized.

At 313, the panel opening sequence routine 300 waits for completion which may be indicated by a timeout, panel displacement, panel driver 112 force limit, or other relevant considerations, events, or triggers and combinations thereof. When the opening sequence routine 300 is done, it ends and continued operation and control of the power panel closure system 101 may be handled by other routines as required, for example routines to continue opening the panel 103 and a panel closing sequence routine.

An exemplary method for operating the power panel closure system 101 through a panel 103 closing sequence routine 500 is illustrated in a flow diagram of FIG. 5 which represent tasks embodied in executable code within control module 125 of FIG. 1. The tasks illustrated in the closing sequence routine 500 may be executed in the order and manner illustrated or may be executed in alternative orders or simultaneously, the closing sequence routine 500 being exemplary. The closing sequence routine 500 may include other tasks not illustrated including system diagnostics.

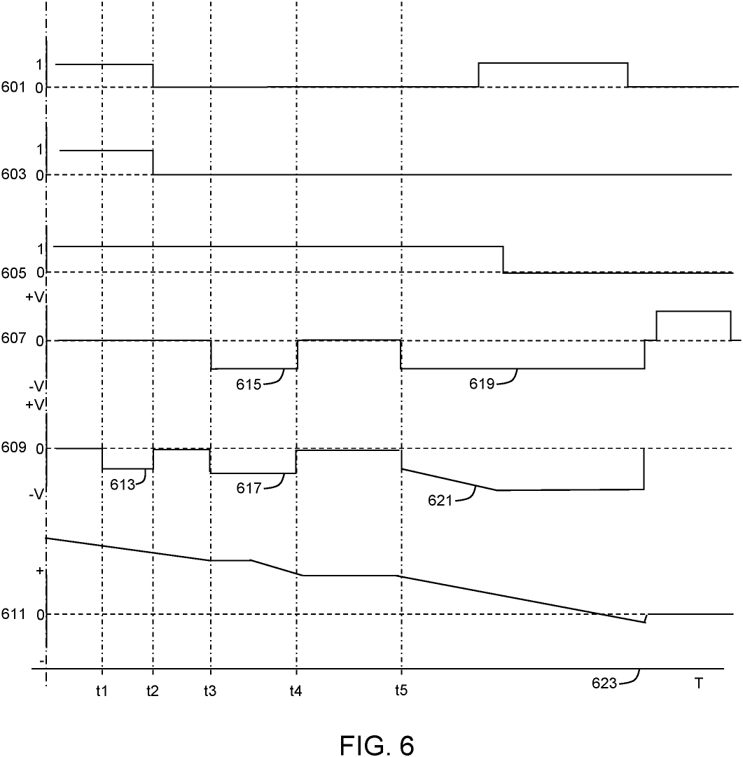

The closing sequence routine 500 may first initialize including clearing or populating memory locations and registers to establish initial settings, variables and calibrations as required and then essentially wait at 503 for receipt of an operator request to close the panel 103. At 505, the panel driver 112 may be commanded to close the panel 103. That is, the panel driver 112 may be energized in a direction associated with movement of the panel 103 toward closing. With reference to chart 609 in FIG. 6, a negative voltage 613 is applied to the panel driver 112 at time t1. The negative voltage corresponds to energization of the panel driver in the first direction associated with panel 103 closing. The voltage level may be between 0 volts and a nominal accessory voltage level for the vehicle, for example 12 volts. In one embodiment, the voltage applied may be about 5 volts but may vary in accordance with the particular application and design factors including the desired panel 103 closing force as the striker catch 203 receives the striker 117 through striker passage 209 to establish the latch mechanism 119 into the secondary latch state. In one embodiment, the voltage level may be established by pulse-width modulation (PWM). FIG. 6 contains other charts further described herein, all of which share a common horizontal time scale (T) 623. The secondary latch state may be validated by state transitions of latch mechanism sensors 124 (charts 601 and 603, FIG. 6) and a panel ajar sensor signal (chart 605, FIG. 6) whereafter the panel driver 112 may be deenergized at time t2. Alternatively, the panel driver 112 may continue to be energized until at least cinching of the panel begins.

At 507, with the latch mechanism 119 in the secondary latch state (201, FIG. 2A), cinching of the panel is commanded. Cinching may be effected in the exemplary latch mechanism 119 by energizing a latch mechanism actuator 123 in the second direction to move the striker catch 203 from the secondary latch state (205, FIG. 2B) to the primary latch state (201, FIG. 2A). With reference to chart 607 in FIG. 6, a negative voltage 615 is applied to the latch mechanism actuator 123 at time t3 to effect cinching. The negative voltage 615 corresponds to energization of the latch mechanism actuator 123 in the second direction. The voltage level 615 may be between 0 volts and a nominal accessory voltage level for the vehicle, for example 12 volts. In one embodiment, the voltage applied may be about 5 volts but may vary in accordance with the particular application and design factors including the bias forces attributed to springs, compressible seals, panel support bumpers and the like as the panel 103 is cinched into the fully closed position. In one embodiment, the voltage level may be established by pulse-width modulation (PWM). Cinching may be assisted by simultaneously energizing the panel driver 112 in the first direction. With reference to chart 609 in FIG. 6, a negative voltage 617 is applied to the panel driver 112 at time t3. The voltage level may be between 0 volts and a nominal accessory voltage level for the vehicle, for example 12 volts. In one embodiment, the voltage applied may be about 5 volts but may vary in accordance with the particular application and design factors including the desired panel 103 closing force. In one embodiment, the voltage level may be established by pulse-width modulation (PWM). By energizing the panel driver 112 to urge the panel 103 toward closing, some or all the bias forces attributed to springs, compressible seals, panel support bumpers and the like may be relieved from the striker 117 and latch mechanism 119 and transferred to the panel driver 112. Essentially, the panel driver 112 may be energized to unload the latch mechanism 119 as it cinches the panel 103. Advantageously, unloading the latch mechanism 119 may reduce the forces needed to cinch the panel 103 thus allowing derating of the latch mechanism actuator 123.

At 509, cinching is paused including any assistance provided by the panel driver 112. As shown in 607 and 609 of FIG. 6, at time t4 the energization of both the panel driver 112 and the latch mechanism actuator 123 is paused for a duration through time t5. Advantageously, such a pause may provide an opportunity for the vehicle operator to remove any obstructions, for example loose or removed clothing, rags, tools, etc., from getting pinched between the panel 103 and the surrounding vehicle structure 111.

At 511, cinching of the panel 103 and energizing the panel driver 112 are once again restarted. With reference to chart 607 in FIG. 6, the negative voltage 619 is applied to the latch mechanism actuator 123 at time t5 to effect cinching. The negative voltage 619 corresponds to energization of the latch mechanism actuator 123 in the second direction. The voltage level 619 may be between 0 volts and a nominal accessory voltage level for the vehicle, for example 12 volts. In one embodiment, the voltage applied may be about 5 volts but may vary in accordance with the particular application and design factors including the bias forces attributed to springs, compressible seals, panel support bumpers and the like as the panel 103 is cinched into the fully closed position. In one embodiment, the voltage level may be established by pulse-width modulation (PWM). Cinching may be assisted by simultaneously energizing the panel driver 112 in the first direction. With reference to chart 609 in FIG. 6, a negative voltage 621 is applied to the panel driver 112 at time t5. The voltage level may be between 0 volts and a nominal accessory voltage level for the vehicle, for example 12 volts. In one embodiment, the voltage level may ramp up from an initial value, for example between 0 and 5 volts, thereby ramping up the corresponding closing force of the panel driver 112. In one embodiment, the voltage applied may be about 5 volts but may vary in accordance with the particular application and design factors including the desired panel 103 closing force. In one embodiment, the voltage level may be established by pulse-width modulation (PWM). By energizing the panel driver 112 to urge the panel 103 toward closing, some or all the bias forces attributed to springs, compressible seals, panel support bumpers and the like may be relieved from the striker 117 and latch mechanism 119 and transferred to the panel driver 112. Essentially, the panel driver 112 may be energized to unload the latch mechanism 119 as it cinches the panel 103. Advantageously, unloading the latch mechanism 119 may reduce the forces needed to cinch the panel 103 thus allowing derating of the latch mechanism actuator 123.

At 513, the panel closing sequence routine 500 waits for completion which may be indicated by a timeout, panel displacement, panel driver 112 force limit, or other relevant considerations, events, or triggers and combinations thereof. When the closing sequence routine 500 is done, it ends and continued operation and control of the power panel closure system 101 may be handled by other routines as required, for example a panel opening sequence routine.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A power panel closure system, comprising:
a moveable panel;
a panel driver energizable in a first direction associated with movement of the panel toward closing and energizable in a second direction associated with movement of the panel toward opening;
a panel latch having a primary latch state wherein the panel is held in a closed position; and
a control module performing a panel opening sequence, comprising:
energizing the panel driver in the first direction while the panel is being held in the closed position by the panel latch in the primary latch state;
releasing the panel latch from the primary latch state; and
energizing the panel driver in the second direction.

2. The system of claim 1, further comprising the panel latch having a secondary latch state wherein the panel is maintained in a partially open position, wherein energizing the panel driver in the second direction opens the panel into the partially open position establishing the panel latch into the secondary latch state.

3. The system of claim 2, wherein the control module performing the panel opening sequence further comprises releasing the panel latch from the secondary latch state.

4. The system of claim 3, wherein energizing the panel driver in the second direction opens the panel beyond the partially open position.

5. The system of claim 2 wherein energizing the panel driver in the second direction comprises ramping up panel driver force.

6. The system of claim 2 wherein energizing the panel driver in the second direction comprises ramping up panel driver force for a predefined duration and subsequently reducing panel driver force prior to releasing the panel latch from the secondary latch state, wherein the control module performing the panel opening sequence further comprises the control module performing the panel opening sequence further comprises releasing the panel latch from the secondary latch state.

7. The system of claim 6 wherein the predefined duration comprises one or more of a time limit, a displacement limit of the panel driver, and a force limit of the panel driver.

8. The system of claim 4 wherein the control module performing the panel opening sequence further comprises:
energizing the panel driver in the first direction when the panel is open beyond the partially open position to close the panel into the partially open position establishing the panel latch into the secondary latch state;
cinching the panel from the partially open position while simultaneously energizing the panel driver in the first direction;
pausing the cinching of the panel and the energizing of the panel driver for a predefined pause duration; and
subsequent to the pause duration, cinching the panel while simultaneously energizing the panel driver in the first direction until the panel latch is in the primary latch state and the panel is held in the closed position.

9. The system of claim 8 wherein energizing the panel driver in the first direction subsequent to the pause duration comprises ramping up panel driver force.

10. A method for operating a power panel closure system, comprising:
energizing a panel driver in a first direction while the panel is latched in a primary latched position, the first direction associated with movement of the panel toward closing;
unlatching the panel from the primary latched position; and
energizing the panel driver in a second direction, the second direction associated with movement of the panel toward opening.

11. The method of claim 10, wherein energizing the panel driver in the second direction opens the panel into a secondary latched position.

12. The method of claim 11, further comprising unlatching the panel from the secondary latched position.

13. The method of claim 12, wherein energizing the panel driver in the second direction opens the panel beyond the secondary latched position.

14. The method of claim 11 wherein energizing the panel driver in the second direction comprises ramping up panel driver force.

15. The method of claim 11 wherein energizing the panel driver in the second direction comprises ramping up panel driver force for a predefined duration and subsequently reducing panel driver force prior to unlatching the panel from the secondary latched position.

16. The method of claim 15 wherein the predefined duration comprises one or more of a time limit, a displacement limit of the panel driver, and a force limit of the panel driver.

17. The method of claim 13 further comprising:
energizing the panel driver in the first direction when the panel is open beyond the secondary latched position to close the panel into the secondary latched position;
cinching the panel from the secondary latched position while simultaneously energizing the panel driver in the first direction;
pausing the cinching of the panel and the energizing of the panel driver for a predefined pause duration; and
subsequent to the pause duration, cinching the panel while simultaneously energizing the panel driver in the first direction until the panel is latched in the primary latched position.

18. The method of claim 17 wherein energizing the panel driver in the first direction subsequent to the pause duration comprises ramping up panel driver force.

19. A power panel closure system for a vehicle, comprising:
a compartment located external to a passenger compartment of the vehicle;
a moveable panel attached to the vehicle by a hinge and having a closed position relative to the compartment;
a panel driver energizable in a first direction associated with movement of the panel toward the closed position and energizable in a second direction associated with movement of the panel away from the closed position;
a panel latch having a primary latch state wherein the panel is held in the closed position; and
a control module performing a panel opening sequence, comprising:
energizing the panel driver in the first direction while the panel is being held in the closed position by the panel latch in the primary latch state;
releasing the panel latch from the primary latch state; and
energizing the panel driver in the second direction.

20. The power panel closure system of claim 19, wherein the compartment comprises a compartment located between a front of the vehicle and the passenger compartment of the vehicle.
